(19) United States
(12) Patent Application Publication
(10) Pub. No.: US 2017/0062802 A1
(43) Pub. Date: Mar. 2, 2017

(54) POLYNARY COMPOSITE OXIDE, PREPARATION METHOD AND USE THEREOF

(71) Applicants: JIN-HONG YANG, Shenzhen (CN); GUO-ZHEN WEI, Shenzhen (CN); WEN-LIAN QIAN, Shenzhen (CN); CHAO ZHENG, Shenzhen (CN)

(72) Inventors: JIN-HONG YANG, Shenzhen (CN); GUO-ZHEN WEI, Shenzhen (CN); WEN-LIAN QIAN, Shenzhen (CN); CHAO ZHENG, Shenzhen (CN)

(21) Appl. No.: 15/352,599

(22) Filed: Nov. 16, 2016

Related U.S. Application Data
(63) Continuation-in-part of application No. PCT/CN2015/007857, filed on May 8, 2015.

(30) Foreign Application Priority Data
May 16, 2014 (CN) 201410208349.4

(51) Int. Cl. H01M 4/131; H01M 4/04; H01M 4/525; H01M 4/505; H01M 4/62; H01M 10/0525

(52) U.S. Cl. CPC H01M 4/131; H01M 4/628; H01M 10/0525; H01M 4/525; H01M 4/505; H01M 4/0497; H01M 2004/028

(57) ABSTRACT

A polynary composite oxide material, a preparation method, and a use thereof are disclosed. The structural formula of this material is Li[LiₖNi_{(a+b)}Co_{c}MnₐZr_{d}]O₂, wherein the element coefficients need to satisfy: 0.03≦k≦0.15, 0.22≦a≦0.33, 0<b≦0.16, 0.30≦c≦0.40, and 0.001≦d≦0.050, k+6a+3b+3c+4d=3 and a+b≦c. This material can be used as a positive electrode active material for a lithium ion battery with high-rate performance and a long cycle life, etc., and can be manufactured on a large scale quickly and at a low cost. This material is suitable for power type lithium ion batteries used in electric vehicles, electric bicycles, and electric tools.

### CROSS-REFERENCE TO RELATED APPLICATIONS

This application is a continuation in part of international Patent Application NO. PCT/CN 2015/078573, filed May 8, 2015, which claims priority to Chinese Patent Application NO. CN201410208349.4, filed May 16, 2014, both of which are hereby incorporated by reference in their entireties.

### FIELD

The subject matter herein generally relates to a manufacturing method of a polynary composite oxide, and use of the polynary composite oxide.

### BACKGROUND

Lithium-ion batteries have some prominent advantages, such as a high energy ratio, high output, long life, and good portability. Lithium-ion batteries can be widely used in portable computers, cell phones, digital devices, electric tools, and other fields.

Electric vehicles and hybrid electric vehicles which use lithium-ion batteries as the power supply body can gradually become the mainstream of new energy vehicles. Lithium iron phosphate is attractive to vehicle power researchers because of its low cost, good safety, and long life. However, with the increasing demand for the mileage, the high and low temperature power performance, and the product consistency of the electric vehicle in the vehicle field, the laminated polynary composite materials gradually become the mainstream cathode materials of the power batteries in this field. In the power type lithium-ion battery field, while ensuring sufficient energy density, attention must be paid to the rate performance to ensure the high power output of the battery, and to the cycle life of the battery to ensure that the battery can be used repeatedly for a long time. Developing the cathode materials, in particular the polynary composite oxide, which have properties of the high rate and the long cycle life, is important.

In the current commercial cathode materials of the lithium-ion batteries, the largest production and sales materials are lithium cobalt oxides and lithium nickel cobalt manganese oxide ternary materials. The lithium nickel cobalt manganese zirconium polynary composite oxide can have a layer structure of α-NaFeO₂ which is similar to the lithium cobalt oxides and the ternary materials. The lithium ion can occupy the 3a sites of the rock salt structure. The nickel ion, the cobalt ion, the manganese ion, and the zirconium ion can occupy the 3b sites of the rock salt structure. The oxide ion can occupy the 6c sites of the rock salt structure. In these kinds of oxides, a transition metal element such as nickel exists in two valence states, Ni²⁺ and Ni³⁺. Transition metal element cobalt exists in Co³⁺, transition metal element manganese exists in Mn⁴⁺, and transition metal element zirconium exists in Zr⁴⁺. Nickel and cobalt elements can participate in electrochemical reaction. Manganese and zirconium elements cannot participate in electrochemical reaction, but can support the crystal framework structure and stabilize the structure. Zirconium element is used as the framework material but not as the cladding material, to better exert the characteristics of good rigidity and stable structure. The design of an industrial production process for a four elements composite of this nature can be problematic.

U.S. Pat. No. 6,964,818B2 discloses an oxide having a general formula Li[M¹₍₁₋ₓ₎Mnₓ]O₂, where 0<x<1, and M¹ can be one or more metal elements. This disclosure has a wide range of metal elements, and has no specific description of the metal elements to satisfy the requirements of high rate and long cycle life. A high rate performance in relation to an understanding of the polynary materials has not been well understood. However, the rate performance is one key requirement of power supply in the field of electric vehicle. Also, a limitation of this disclosure was that all of the Ni elements in the formula can exist in valence of +2 in the air, thus limiting the material which is not conductive to improve the rate performance of the material.

Chinese Patent publication NO. CN 100526222C discloses a manufacturing method of a single phase compound including the transition metal oxides of cobalt, manganese, nickel, and lithium. This method can emphasis the technology of wet grinding and re-heating. The grinding time of wet grinding was believed to be shorter than that of dry grinding, thus shortening the grinding time, but was not thought to be suitable for the development of materials with high rate and long cycle life.

Research into oxide materials with layered polynary composite structures, the design of the appropriate element ratio in view of the high rate and long cycle life, and the synthesis of high rate and long life of polynary composite oxide in industrial production shows the practical significance of realizing the production of cathode materials of lithium-ion batteries with high quality. Performances of lithium-ion batteries are improved and the application field of lithium-ion batteries is expanded, to promote the development of new pollution-free energy vehicles.

### SUMMARY OF THE INVENTION

One object of the present disclosure is to provide a polynary composite oxide with high rate and long cycle life.

In order to achieve the above objective, the present disclosure provides a polynary composite oxide. The polynary composite oxide is a lithium nickel cobalt manganese zirconium polynary composite oxide having a general formula of Li[LiₖNi_{(a+b)}Co_{c}MnₐZr_{d}]O₂, where the element coefficients meet the relation 0.03≦k≦0.15, 0.22≦0.33, 0<b≦0.16, 0.30≦c≦0.40, 0.001≦d≦0.050. Preferably k+6a+3d+3c+4d=3 and a+b≦c.

The present disclosure also provides a method for manufacturing the polynary composite oxide including the steps of:

(1) preparing 0.1˜5.0 mol/L of solution A1 with soluble cobalt salt and soluble nickel salt, preparing 0.1˜5.0 mol/L of solution A2 with soluble manganese salt and soluble zirconium salt, mixing the solution A1 and the solution A2 by a certain stoichiometric ratio to obtain solution A, and strongly stirring the solution A at a rotating rate of 100˜800 r/min;

(2) adding 0.2˜12.0 mol/L of precipitant and 0.5˜10.0 mol/L of accessory ingredient into the mixing solution A, and adjusting the mixing solution A to a pH value of 10.5˜12.0 to achieve gradual subsidence of intermediate B;

(3) washing the intermediate B to remove the remaining anions thereon;

(4) mixing the intermediate B and lithium salt to obtain a uniform precursor C of gray color, where the molar ratio of lithium element is less than 5˜20%;

(5) placing the precursor C powder into a high temperature roller kiln to be decomposed and oxidated, so as to obtain primary powder D;

(6) placing the primary powder D and some organic phase into a preparation tank, stirring the primary powder and the organic phase at the rotating rate of 100˜500 r/min, pumping the slurry into the intermediate tank, and then heating and mixing the slurry, preferably heating to 50˜90 degrees celsius and stirring for 0.5˜8 hours to obtain rheological phase E;

(7) heat treating the rheological phase E on the plate to obtain secondary powder F, preferably the heat treating temperature is 150˜450 degrees celsius, the heating treating time is 2˜6 hours;

(8) adding 0.03˜2.00 mass percent of surface additive into the secondary powder F, evenly mixing the surface additive and the second powder F, and sintering that with high temperature to obtain the polynary composite oxide. Preferably the sintering temperature is 750˜1000 degrees celsius, the sintering time is 4˜20 hours.

Further, the soluble cobalt salt is cobalt sulfate, cobalt chloride, cobalt acetate, or cobalt nitrate. The soluble nickel salt is nickel sulfate, nickel chloride, nickel acetate, or nickel nitrate. The soluble manganese salt is manganese sulfate, manganese chloride, manganese acetate, or manganese nitrate. The soluble zirconium salt is zirconium sulfate, zirconium chloride, zirconium acetate, or zirconium nitrate.

Further, the precipitant is one or more selected from the group consisting of sodium hydroxide, potassium hydroxide, sodium carbonate, potassium carbonate, ammonium hydrogen carbonate, and lithium hydroxide. The accessory ingredient is ethylenediamine tetraacetic acid, ammonia, ammonium citrate, ethylenediamine, or ammonium acetate.

Further, the anion is one or more selected from the group consisting of sulfate, chloride, acetate, nitrate, and hydroxide.

Further, the lithium salt is one or more selected from the group consisting of lithium carbonate, lithium hydroxide, and lithium acetate.

Further, the organic phase is ethyl alcohol, propyl alcohol, ethylene glycol, or hexylene glycol.

Further, the surface additive is one or more selected from the group consisting of lanthanum oxide, lithium fluoride, lithium acetate, ammonium hydrogen fluoride, ammonium bicarbonate, aluminum fluoride, alumina, aluminum hydroxide, ammonium paratungstate, tungsten trioxide, ammonium molybdate, molybdenum oxide, zirconium oxide, zirconium hydroxide, manganese dioxide, cobaltosic oxide, cobalt hydroxide, citric acid, oxalic acid, basic magnesium carbonate, magnesium oxide, and calcium carbonate.

The present disclosure further provides a positive electrode active material including the polynary composite oxide. In other words, the polynary composite oxide can be used as a positive electrode active material for a lithium ion battery.

The polynary composite oxide can be industrially synthesized by the preparation method. The high rate performance, long cycle life, and stability of the material can be improved to be suitable for the fields of electric vehicles, the electric bicycles, the electric tools, and power type lithium ion batteries. In order to solve problems, the technical solution of the present invention is as follows.

The polynary composite oxide is a lithium nickel cobalt manganese zirconium polynary composite oxide having a general formula of Li[LiₖNi_{(a+b)}Co_{c}MnₐZr_{d}]O₂. In order to obtain high rate performance and the long cycle life of the polynary composite oxide material, the element coefficients must meet the relation 0.03≦k≦0.15, 0.22≦0.33, 0<b≦0.16, 0.30≦c≦0.40, 0.001≦d≦0.050. In order to ensure the charge balance of the polynary composite oxide material, the element coefficients must meet the relation k+6a+3d+3c+4d=3. In order to obtain the long cycle life of the batteries, the element coefficients must meet the relation a+b≦c.

The preparation method of the polynary composite oxide includes the steps of:

(1) preparing the solution A1 with the soluble cobalt salt and the soluble nickel salt, preparing the solution A2 with the soluble manganese salt and the soluble zirconium salt, and mixing the solution A1 and the solution A2 by a certain stoichiometric ratio to obtain solution A. The solution A is strongly stirred. The soluble cobalt salt is cobalt sulfate, cobalt chloride, cobalt acetate, or cobalt nitrate. The soluble nickel salt is nickel sulfate, nickel chloride, nickel acetate, or nickel nitrate. The soluble manganese salt is manganese sulfate, manganese chloride, manganese acetate, or manganese nitrate. The soluble zirconium salt is zirconium sulfate, zirconium chloride, zirconium acetate, or zirconium nitrate and the stirring rate of the solution A is 100˜800 r/min;

(2) adding the precipitant and the accessory ingredient into the mixing solution A, and adjusting the mixing solution A to a pH value of 10.5˜12.0 to achieve gradual subsidence of intermediate B. The precipitant is one or more selected from the group consisting of sodium hydroxide, potassium hydroxide, sodium carbonate, potassium carbonate, ammonium hydrogen carbonate, and lithium hydroxide. The accessory ingredient is ethylenediamine tetraacetic acid, ammonia, ammonium citrate, ethylenediamine, or ammonium acetate;

(3) washing the intermediate B to remove the remaining anions, the anions are one or more selected from the group consisting of sulfate, chloride, acetate, nitrate, and hydroxide;

(4) mixing the intermediate B and the lithium salt to obtain the gray precursor C. The lithium salt is one or more selected from the group consisting of lithium carbonate, lithium hydroxide, and lithium acetate;

(5) decomposing and oxidating the precursor C to obtain primary powder D, the precursor C being placed into the high temperature roller kiln to be decomposed and oxidated.

(6) placing the primary powder D into the preparation tank and pumping some organic phase into the preparation tank. Stirring the primary powder and the organic phase, pumping the slurry into the intermediate tank, and then heating the slurry to 50˜90 degrees celsius and then mixing the slurry to obtain rheological phase E. The organic phase is ethyl alcohol, propyl alcohol, ethylene glycol or hexylene glycol, the stirring rate is 100˜500 r/min, and the stirring time is 0.5˜8 hours;

(7) heat treating the rheological phase E on the plate to obtain secondary powder F, the heat treating temperature being 150˜450 degrees celsius, and the heating treating time being 2˜6 hours;

(8) adding the surface additive into the secondary powder F, evenly mixing the surface additive and the second powder F, and sintering that with high temperature to obtain the polynary composite oxide. The surface additive is one or more selected from the group consisting of lanthanum oxide, lithium fluoride, lithium acetate, ammonium hydrogen fluoride, ammonium bicarbonate, aluminum fluoride, alumina, aluminum hydroxide, ammonium paratungstate, tungsten trioxide, ammonium molybdate, molybdenum oxide, zirconium oxide, zirconium hydroxide, manganese dioxide, cobaltosic oxide, cobalt hydroxide, citric acid, oxalic acid, basic magnesium carbonate, magnesium oxide, and calcium carbonate. The amount of the additive is 0.03˜2 mass percent of the secondary powder and the sintering temperature is 750˜1000 degrees celsius, the sintering time being 4˜20 hours.

The polynary composite oxide with high rate and long cycle life is manufactured by firstly mixing the soluble cobalt, the soluble nickel salt, the soluble manganese salt and the soluble zirconium salt. The precipitant and the accessory ingredient are added, and the pH value adjusted to a value of 10.5˜12.0. The intermediate B is washed, the intermediate B and the lithium salt are mixed to obtain the precursor, and then decomposing and oxidating are applied. The primary powder D is placed into the preparation tank to be heat treated to obtain the secondary powder with the heating temperature of 150˜450 degrees celsius, and then adding the surface additive, and sintering with the sintering temperature of 750˜1000 degrees celsius. The polynary composite oxide can be used as the positive electrode active material of the lithium-ion batteries. Testing shows that the positive electrode active materials also have the advantages of high rate and long cycle life. The manufacturing method can be used in the industry to quickly manufacture large amounts of the positive materials with low cost. High quality cathode materials of lithium-ion batteries are achieved, and the performance of lithium-ion batteries is improved The application field of lithium-ion batteries is expanded, to promote the development of new pollution-free energy vehicles.

The advantages of the present disclosure are as follows.

When the primary powder is prepared by a precipitation-oxidation method, a uniform mixing of the solution at the molecular level according to the stoichiometric ratio is carried out, and then the oxidation forms an oxide having metal elements which are distributed uniformly. After the primary powder is placed into the organic phase, the solution phase is changed to the sol phase by the beating operation in industrial production. The sol phase is changed to the rheological phase by strong stirring to gradually form the quasi-condensed form or quasi-crystal form. The rheological phase method is a kind of method which is between the solid phase method and the sol-gel method. Compared with the traditional solid phase method, the rheological phase method has an effect of uniformly mixing. Compared with the sol-gel method, the rheological phase method will evaporate less solvent. Therefore, it has the advantages of low energy consumption and industrial production is easy to realize. The secondary powders obtained by heating process are quasi-condensed or quasi-crystalline, and the deviation of the stoichiometric ratio is also within the controllable production index. The oxide materials are still inevitably with the side effects of the electrolyte in the process of making and using the batteries, and the cycle life of the materials can thus be affected. The surface additives can be added at the end of the process to form a protection layer on the oxide crystal, thus suppressing the side effects of the oxide materials in the electrolyte. The manufacturing method can be completed using industrial equipment which includes reactor, high temperature roller kiln, preparation tank, industrial pump, thermal processor, and so on.

The polynary composite oxide is used as the positive electrode active material to form the lithium-ion batteries. The batteries also have advantages of excellent rate performance and cycle life performance, stable processing performance, good safety performance, and high temperature performance.

### BRIEF DESCRIPTION OF THE DRAWINGS

Implementations of the present technology will now be described, by way of example only, with reference to the attached figures.

FIG. 1 is a flowchart of an embodiment of a method for preparing the polynary composite oxide.

FIG. 2 is a scanning electron microscope (SEM) image (7000×˜40000×) of the first embodiment of the polynary composite oxide.

FIG. 3 is an x-ray diffraction (XRD) pattern of the first embodiment of the polynary composite oxide.

FIG. 4 is a scanning electron microscope (SEM) image (9000×˜45000×) of a second embodiment of polynary composite oxide.

FIG. 5 is an x-ray diffraction (XRD) pattern of a third embodiment of polynary composite oxide.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

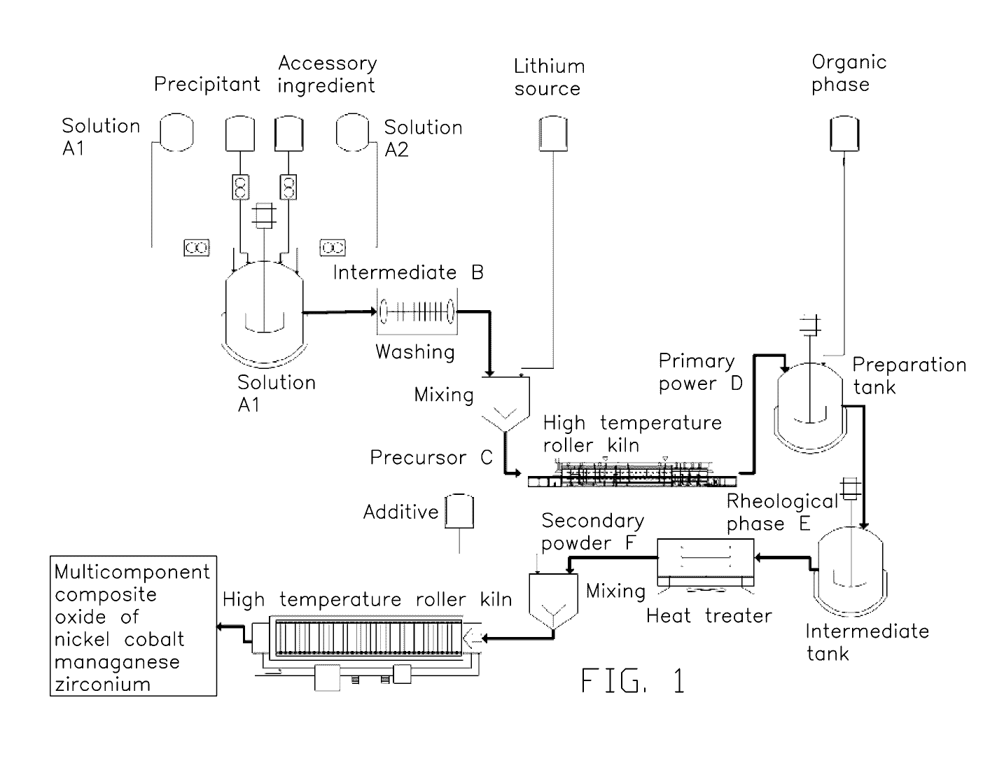

The unspecified reagents and the equipment are generally available. The polynary composite oxides of the following example can be prepared in accordance with the flowchart of FIG. 1.

### Example 1

The nickel sulfate and the cobalt sulfate were mixed at a molar ratio of Ni:Co=0.331:0.379 to prepare 1 mol/L of a first solution. The manganese sulfate and the zirconium sulfate were mixed at a molar ratio of Mn:Zr=0.237:0.029 to prepare 1 mol/L of a second solution, and the first and second solutions were mixed and stirred at a rotating rate of 200 r/min. 5 mol/L of the sodium hydroxide solution and 5 mol/L of the ammonia were added into the mixed solution, and then the mixed solution adjusted to a pH value of 11.5 to gradually subside intermediate. The intermediate was washed and mixed with the lithium carbonate, where molar ratio of the lithium element is less than 10%, and then placed into the high temperature roller kiln to be decomposed and oxidated, to obtain the primary powder. Then primary powder was placed into the preparation tank, and ethylene glycol was pumped in the preparation tank, and then the primary powder and the ethylene glycol were stirred at the rotating rate of 150 r/min. The slurry formed after stirring was pumped into the intermediate tank, and then heated to 90 degrees celsius and stirred for 0.5 hours to obtain the rheological phase. The rheological phase was on the plate, and then heat treated to obtain secondary powder with the heat treating temperature of 450 degrees celsius and the heat treating time for 6 hours. 0.05 mass percent of the aluminum fluoride was added into the secondary powder to be uniformly mixed, and then the mixed material was sintered to obtain the polynary composite oxide having a chemical formula of Li[Li_{0.042}Ni_{0.331}Co_{0.379}Mn_{0.237}Zr_{0.029}]O₂, with the sintering temperature of 850 degrees celsius and the sintering time for 8 hours.

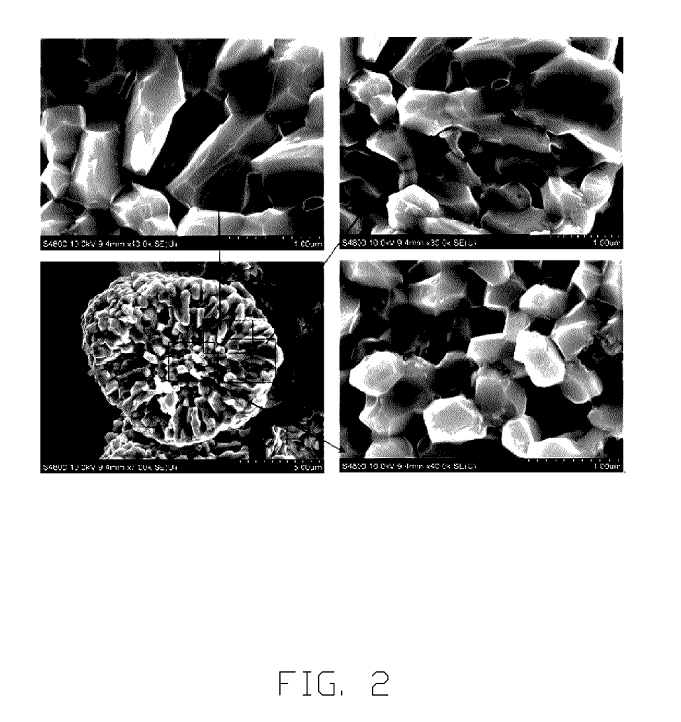

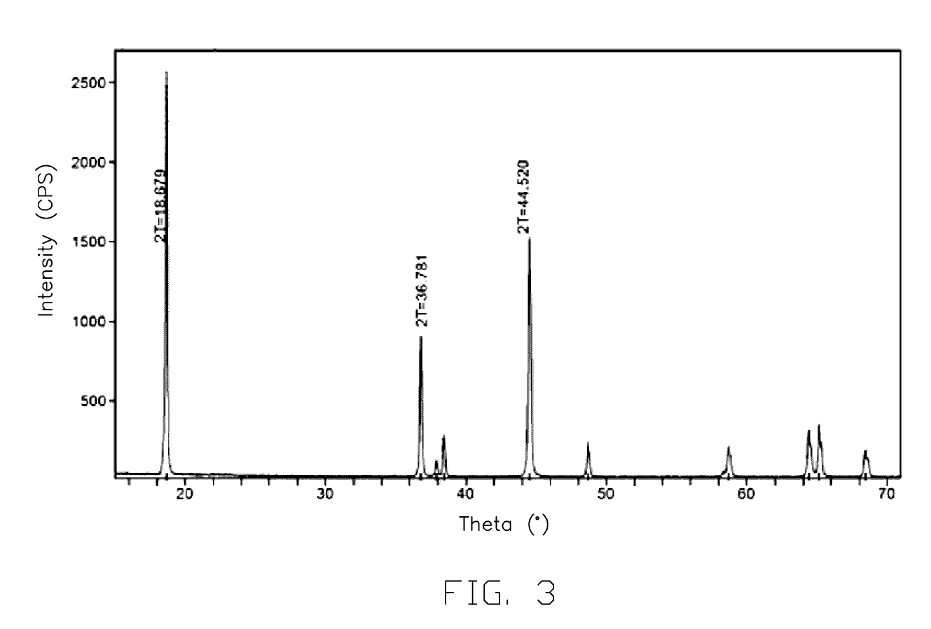

The surface fractures of the testing materials were investigated by SEM, performed by Hitachi scanning electron microscope, the test result shown in FIG. 2. FIG. 2 illustrates that a number of small crystal primary particles can be formed as spherical secondary particles, the grain boundaries of the material can be combined closely, and the crystal type thereof can be in good condition. The content of the metal ions can be determined by thermo-electric inductively coupled plasma atomic emission spectrometry, and the molar ratio of the content of the testing materials is Li:Ni:Co:Mn:Zr=1.042:0.331:0.379:0.237:0.029. The structure of the test materials were investigated by XRD which is performed with a Brook (a company in Germany) x-ray diffractometer, using a Ka x-ray source, and an x-ray wavelength λ=1.5406, the test result shown in FIG. 3. FIG. 3 illustrates that the test materials were a single structure with an NaFeO₂ structure.

A positive pole piece formed with the product of the first embodiment, the conductive agent and the binder at a ratio of 92:5:3, a carbon cathode, a separator, and an electrolyte were cooperatively assembled into a battery. The discharge rate performance (10C/1C discharge capacity ratio %, 20 degrees celsius), the low temperature power performance (10C discharge resistance mΩ, −20 degrees celsius), and the cycle performance (1000 week capacity retention %, 20 degrees celsius) of the battery were tested on a battery tester. The test result shown in table 1 illustrates that the material formed in example 1 achieved the desired objectives.

### Example 2

The nickel sulfate and the cobalt sulfate were mixed at a molar ratio of Ni:Co=0.317:0.363 to prepare 0.1 mol/L of a first solution. The manganese sulfate and the zirconium sulfate were mixed at a molar ratio of Mn:Zr=0.227:0.048 to prepare 0.1 mol/L of a second solution, and these solutions were mixed and stirred at a rotating rate of 200 r/min. 0.2 mol/L of the potassium hydroxide solution and 0.5 mol/L of the ammonia were added into the mixed solution, and then the mixed solution adjusted to a pH value of 11.0 to gradually subside intermediate. The intermediate was washed and mixed with the lithium carbonate, the molar ratio of lithium element being less than 20%, and then placed into the high temperature roller kiln to be decomposed and oxidated, to obtain the primary powder. Then primary powder was placed into the preparation tank, and hexylene glycol pumped in the preparation tank, and then the primary powder and the hexylene glycol were stirred at the rotating rate of 100 r/min. The slurry formed after stirring was pumped into the intermediate tank, and then heated to 50 degrees celsius and stirred for 8 hours to obtain the rheological phase. The rheological phase was on the plate, and was heat treated to obtain secondary powder with the heat treating temperature of 450 degrees celsius and the heat treating time for 6 hours. 0.5 mass percent of the aluminum oxide was added into the secondary powder to be uniformly mixed, and then the mixed material was sintered to obtain the polynary composite oxide having a chemical formula of Li[Li_{0.088}Ni_{0.317}Co_{0.363}Mn_{0.227}Zr_{0.048}]O₂, with the sintering temperature of 900 degrees celsius and the sintering time for 12 hours.

### Example 3

The nickel sulfate and the cobalt sulfate were mixed at a molar ratio of Ni:Co=0.333:0.381 to prepare 3 mol/L of a first solution. The manganese sulfate and the zirconium sulfate were mixed at a molar ratio of Mn:Zr=0.238:0.001 to prepare 3 mol/L of a second solution, and these solutions mixed and stirred at a rotating rate of 100 r/min. 6 mol/L of the sodium carbonate solution and 6 mol/L of the ammonia were added into the mixed solution, and the mixed solution adjusted to a pH value of 11.0 to gradually subside intermediate. The intermediate was washed and mixed with the lithium carbonate, where the molar ratio of lithium element is less than 20%, and then placed into the high temperature roller kiln to be decomposed and oxidated to obtain the primary powder. Then primary powder was placed into the preparation tank, and ethyl alcohol was pumped in the preparation tank, and then the primary powder and the ethyl alcohol were stirred at the rotating rate of 100 r/min. The slurry formed after stirring was pumped into the intermediate tank, and then heated to 60 degrees celsius and stirred for 6 hours to obtain the rheological phase. The rheological phase was on the plate, and then was heat treated to obtain secondary powder with the heat treating temperature of 150 degrees celsius and the heat treating time for 8 hours. 0.03 mass percent of the cobaltosic oxide was added into the secondary powder to be uniformly mixed, and then the mixed material was sintered to obtain the polynary composite oxide having a chemical formula of Li[Li_{0.142}Ni_{0.333}Co_{0.381}Mn_{0.238}Zr_{0.001}]O₂, with the sintering temperature of 900 degrees celsius and the sintering time for 12 hours.

### Example 4

The nickel sulfate and the cobalt sulfate were mixed at a molar ratio of Ni:Co=0.314:0.324 to prepare 5 mol/L of a first solution. The manganese sulfate and the zirconium sulfate were mixed at a molar ratio of Mn:Zr=0.237:0.029 to prepare 5 mol/L of a second solution, and these solutions were mixed and stirred at a rotating rate of 800 r/min. 7 mol/L of the ammonium hydrogen carbonate solution and 6 mol/L of the ammonia were added into the mixed solution, and then the mixed solution was adjusted to a pH value of 12.0 to gradually subside intermediate. The intermediate was washed and mixed with the lithium carbonate, where the molar ratio of lithium element was less than 20%, and then placed into the high temperature roller kiln to be decomposed and oxidated to obtain the primary powder. Then primary powder was placed into the preparation tank, and propyl alcohol was pumped in the preparation tank, and then the primary powder and the propyl alcohol were stirred at the rotating rate of 100 r/min. The slurry formed after stirring was pumped into the intermediate tank, and then heated to 50 degrees celsius and stirred for 8 hours to obtain the rheological phase. The rheological phase was on the plate, and then was heat treated to obtain secondary powder with the heat treating temperature of 450 degrees celsius and the heat treating time for 2 hours. 0.03 mass percent of the lanthanum oxide was added into the secondary powder to be uniformly mixed, and then the mixed material was sintered to obtain the polynary composite oxide having a chemical formula of Li[Li_{0.142}Ni_{0.314}Co_{0.324}Mn_{0.314}Zr_{0.001}]O₂, with the sintering temperature of 1000 degrees celsius and the sintering time for 12 hours.

### Example 5

The nickel sulfate and the cobalt sulfate were mixed at a molar ratio of Ni:Co=0.326:0.335 to prepare 1 mol/L of a first solution. The manganese sulfate and the zirconium sulfate were mixed at a molar ratio of Mn:Zr=0.326:0.001 to prepare 1 mol/L of a second solution, and these solutions were mixed and stirred at a rotating rate of 300 r/min. 8 mol/L of the lithium hydroxide solution and 2 mol/L of the ethylenediamine tetraacetic acid were added into the mixed solution, and then the mixed solution was adjusted to a pH value of 10.5 to gradually subside intermediate. The intermediate was washed and mixed with the lithium carbonate, where the molar ratio of lithium element was less than 5%, and then placed into the high temperature roller kiln to be decomposed and oxidated to obtain the primary powder. Then primary powder was placed into the preparation tank, and ethylene glycol was pumped in the preparation tank, and then the primary powder and the ethylene glycol were stirred at the rotating rate of 100 r/min. The slurry formed after stirring was pumped into the intermediate tank, and then heated to 350 degrees celsius and stirred for 8 hours to obtain the rheological phase. The rheological phase was on the plate, and then was heat treated to obtain secondary powder with the heat treating temperature of 450 degrees celsius and the heat treating time for 6 hours. 0.2 mass percent of the lithium acetate was added into the secondary powder to be uniformly mixed, and then the mixed material was sintered to obtain the polynary composite oxide having a chemical formula of Li[Li_{0.036}Ni_{0.326}CO_{0.335}Mn_{0.326}Zr_{0.001}]O₂, with the sintering temperature of 850 degrees celsius and the sintering time for 10 hours.

### Example 6

The nickel sulfate and the cobalt sulfate were mixed at a molar ratio of Ni:Co=0.299:0.308 to prepare 1 mol/L of a first solution and the manganese sulfate and the zirconium sulfate were mixed at a molar ratio of Mn:Zr=0.299:0.048 to prepare 1 mol/L of a second solution These two solutions were mixed and stirred at a rotating rate of 200 r/min. 5 mol/L of the lithium hydroxide solution and 5 mol/L of the ammonia were added into the mixed solution, and then the mixed solution was adjusted to a pH value of 11.0 to gradually subside intermediate. The intermediate was washed and mixed with the lithium carbonate, where the molar ratio of lithium element is less than 20%, and then placed into the high temperature roller kiln to be decomposed and oxidated to obtain the primary powder. Then primary powder was placed into the preparation tank, and ethylene glycol was pumped in the preparation tank, and then the primary powder and the ethylene glycol were stirred at the rotating rate of 100 r/min. The slurry formed after stirring was pumped into the intermediate tank, and then heated to 55 degrees celsius and stirred for 4 hours to obtain the rheological phase. The rheological phase was on the plate, and then was heat treated to obtain secondary powder with the heat treating temperature of 450 degrees celsius and the heat treating time for 6 hours. 0.05 mass percent of the ammonium molybdate was added into the secondary powder to be uniformly mixed, and then the mixed material sintered to obtain the polynary composite oxide having a chemical formula of Li[Li_{0.088}Ni_{0.299}Co_{0.308}Mn_{0.299}Zr_{0.048}]O₂, with the sintering temperature of 800 degrees celsius and the sintering time for 8 hours.

### Example 7

The nickel sulfate and the cobalt sulfate were mixed at a molar ratio of Ni:Co=0.345:0.395 to prepare 1 mol/L of a first solution and the manganese sulfate and the zirconium sulfate were mixed at a molar ratio of Mn:Zr=0.247:0.001 to prepare 1 mol/L of a second solution. These two solutions were mixed and stirred at a rotating rate of 300 r/min. 12 mol/L of the potassium hydroxide solution and 5 mol/L of the ammonia were added into the mixed solution, and then the mixed solution was adjusted to a pH value of 11.5 to gradually subside intermediate. The intermediate was washed and mixed with the lithium carbonate, where the molar ratio of lithium element is less than 5%, and then placed into the high temperature roller kiln to be decomposed and oxidated to obtain the primary powder. Then primary powder was placed into the preparation tank, and ethyl alcohol was pumped in the preparation tank, and then the primary powder and the ethyl alcohol were stirred at the rotating rate of 800 r/min. The slurry formed after stirring was pumped into the intermediate tank, and then heated to 80 degrees celsius and stirred for 8 hours to obtain the rheological phase. The rheological phase was on the plate, and then was heat treated to obtain secondary powder with the heat treating temperature of 350 degrees celsius and the heat treating time for 5 hours. 1.00 mass percent of the manganese dioxide and 2.00 mass percent of the citric acid were added into the secondary powder to be uniformly mixed, and then the mixed material was sintered to obtain the polynary composite oxide having a chemical formula of Li[Li_{0.036}Ni_{0.345}Co_{0.395}Mn_{0.247}Zr_{0.001}]O₂, with the sintering temperature of 750 degrees celsius and the sintering time for 9 hours.

### Example 8

The nickel sulfate and the cobalt sulfate were mixed at a molar ratio of Ni:Co=0.315:0.349 to prepare 5 mol/L of a first solution and the manganese sulfate and the zirconium sulfate were mixed at a molar ratio of Mn:Zr=0.305:0.005 to prepare 5 mol/L of a second solution. These two solutions were mixed and stirred at a rotating rate of 200 r/min. 5 mol/L of the sodium hydroxide solution and 10 mol/L of the ammonia were added into the mixed solution, and then the mixed solution was adjusted to a pH value of 12.0 to gradually subside intermediate. The intermediate was washed and mixed with the lithium carbonate, where the molar ratio of lithium element is less than 11%, and then placed into the high temperature roller kiln to be decomposed and oxidated to obtain the primary powder. Then primary powder was placed into the preparation tank, and ethyl alcohol was pumped in the preparation tank, and then the primary powder and the ethyl alcohol were stirred at the rotating rate of 100 r/min. The slurry formed after stirring was pumped into the intermediate tank, and then heated to 90 degrees celsius and stirred for 3 hours to obtain the rheological phase. The rheological phase was on the plate, and then was heat treated to obtain secondary powder with the heat treating temperature of 250 degrees celsius and the heat treating time for 7 hours. 0.05 mass percent of the basic magnesium carbonate was added into the secondary powder to be uniformly mixed, and then the mixed material was sintered to obtain the polynary composite oxide having a chemical formula of Li[Li_{0.075}Ni_{0.315}Co_{0.349}Mn_{0.305}Zr_{0.005}]O₂, with the sintering temperature of 900 degrees celsius and the sintering time for 4 hours.

### Comparative Example 1

The nickel sulfate, the cobalt sulfate and the manganese sulfate were mixed at a molar ratio of Ni:Co=1:1:1 to prepare 1 mol/L of a solution and 5 mol/L of the sodium hydroxide solution and 5 mol/L of the ammonia were added into the solution. The solution was adjusted to a pH value of 11.0 to gradually subside intermediate. The intermediate was washed and mixed with the lithium carbonate without excessive lithium, and then was sintered to obtain the polynary composite oxide having a chemical formula of Li[Ni_{1/3}Co_{1/3}Mn_{1/3}]O₂, with the sintering temperature of 850 degrees celsius and the sintering time for 12 hours.

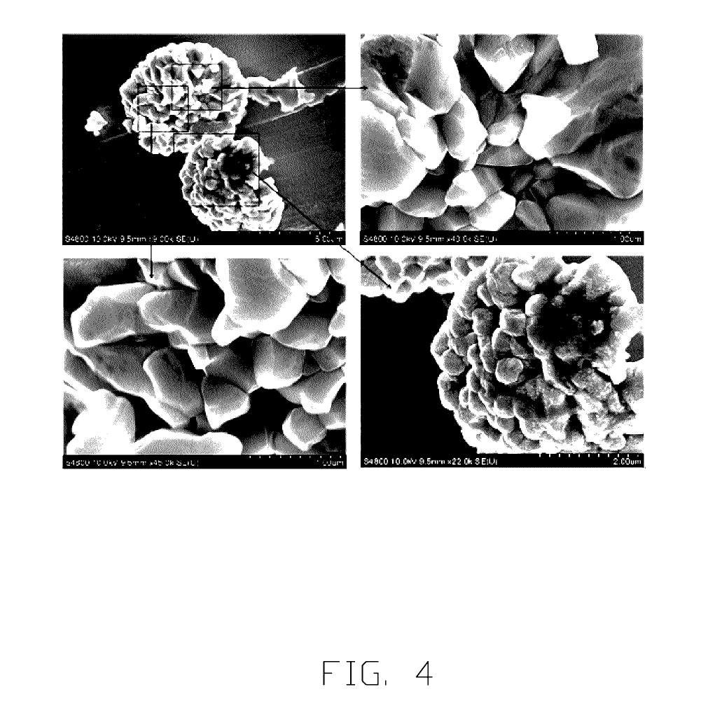

The polynary composite oxide prepared in comparative example 1 is not within the scope of the present invention. The polynary composite oxide includes nickel existing in Ni²⁺, not nickel existing in Ni³⁺ form. The fractured surface of the material is shown in FIG. 4, the fracture surface of the material of the comparative example 1 is similar to fracture surface of the material of the example 1. In other words, a number of small crystal primary particles can be formed as spherical secondary particles, but the grain boundaries of the material cannot be combined closely, and irregular shape prevents the crystal type thereof being in good condition. The battery can be formed by the method similar to that of the example 1. The discharge rate performance (10C/1C discharge capacity ratio %, 20 degrees celsius), the low temperature power performance (10C discharge resistance mΩ, −20 degrees celsius), and cycle performance (1000 week capacity retention %, 20 degrees celsius) of the battery were tested on the battery tester. The test result shown in table 1 illustrates that the material formed in comparative example 1 does not achieve the desired objectives.

### Comparative Example 2

The nickel sulfate and the cobalt sulfate were mixed at a molar ratio of Ni:Co=0.405:0.335 to prepare 1 mol/L of a first solution, the manganese sulfate and the zirconium sulfate were mixed at a molar ratio of Mn:Zr=0.247:0.001 to prepare 1 mol/L of a second solution. These two solutions were mixed and stirred at a rotating rate of 200 r/min. 5 mol/L of the sodium hydroxide solution and 5 mol/L of the ammonia were added into the mixed solution, and then the mixed solution was adjusted to a pH value of 11.5 to gradually subside intermediate. The intermediate was washed and mixed with the lithium carbonate, where the molar ratio of lithium element is less than 5%, and then placed into the high temperature roller kiln to be decomposed and oxidated to obtain the primary powder. Then primary powder was placed into the preparation tank, and ethylene glycol pumped in the preparation tank, and then the primary powder and the ethylene glycol were stirred at the rotating rate of 100 r/min. The slurry formed after stirring was pumped into the intermediate tank, and then heated to 90 degrees celsius and stirred for 2 hours to obtain the rheological phase. The rheological phase was on the plate, and then was heat treated to obtain secondary powder with the heat treating temperature of 450 degrees celsius and the heat treating time for 6 hours. 0.5 mass percent of the aluminum oxide was added into the secondary powder to be uniformly mixed, and then the mixed material was sintered to obtain the polynary composite oxide having a chemical formula of Li[Li_{0.036}Ni_{0.405}Co_{0.335}Mn_{0.247}Zr_{0.001}]O₂, with the sintering temperature of 800 degrees celsius and the sintering time for 4 hours.

The polynary composite oxide prepared in comparative example 1 is not within the scope of the present invention. The test result shown in table 1 illustrates that the material formed in comparative example 2 does not achieve the desired objectives.

### Comparative Example 3

The nickel sulfate, the cobalt sulfate, and the manganese sulfate were mixed at a molar ratio according to the Ni_{0.331}Co_{0.379}Mn_{0.237}@Zr_{0.029} to prepare 1 mol/L of a solution, this solution was stirred at a rotating rate of 200 r/min. 5 mol/L of the sodium hydroxide solution and 5 mol/L of the ammonia were added into the solution, and then the mixed solution was adjusted to a pH value of 11.5 to gradually subside intermediate. The intermediate was washed and mixed with the lithium carbonate, where the molar ratio of lithium element is less than 10%, and then placed into the high temperature roller kiln to be decomposed and oxidated to obtain the primary powder. Then primary powder was placed into the preparation tank, and ethylene glycol pumped in the preparation tank, and then the primary powder and the ethylene glycol were stirred at the rotating rate of 150 r/min. The slurry formed after stirring was pumped into the intermediate tank, and then heated to 90 degrees celsius and stirred for 0.5 hours to obtain the rheological phase. The rheological phase was on the plate, and then was heat treated to obtain secondary powder with the heat treating temperature of 450 degrees celsius and the heat treating time for 6 hours. 0.05 mass percent of the aluminum fluoride was added into the secondary powder to be uniformly mixed, and then the mixed material was sintered to obtain the polynary composite oxide having a chemical formula of Li[Li_{0.042}Ni_{0.331}Co_{0.379}Mn_{0.237}]O₂@[ZrO₂]_{0.029}, with the sintering temperature of 850 degrees celsius and the sintering time for 8 hours.

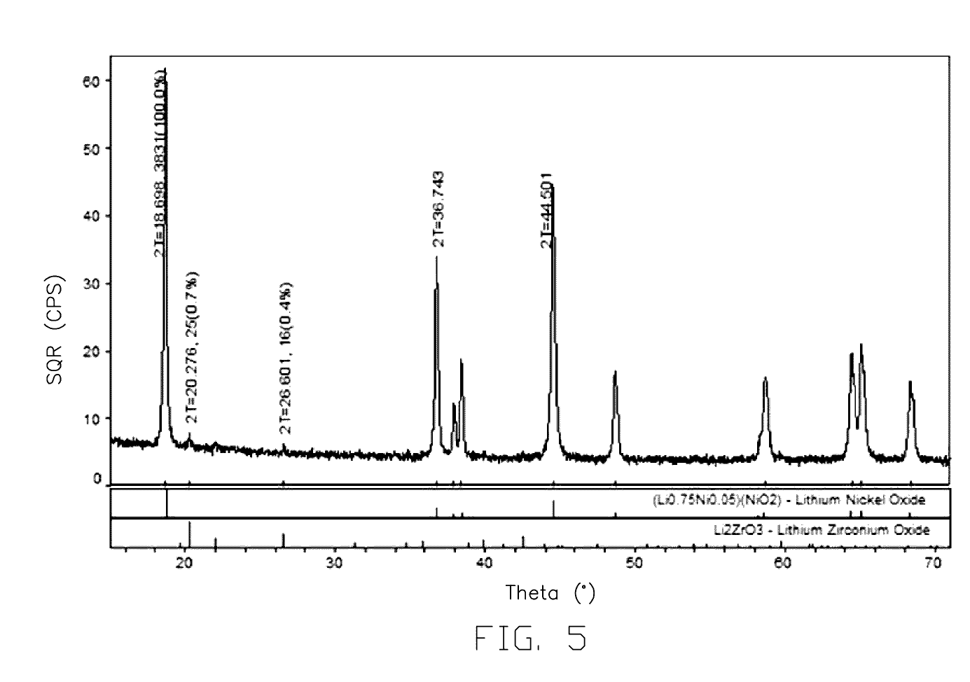

The ratio of nickel, cobalt, manganese, zirconium of the polynary composite oxide of comparative example 3 can be the same as that of the polynary composite oxide formed in example 1, but the zirconium element is not added until the end. FIG. 5 illustrates an x-ray diffraction (XRD) pattern of the material formed in comparative example 3. Compared with example 1, the material formed in comparative example 3 is not a single structure with an NaFeO₂ structure, there is a miscellaneous phase of Li₂ZrO₃ in the position of 2T=20.276 and 26.601. This indicates that the zirconium element is not well integrated into the lattice of the polynary composite materials, the materials are only ternary composite materials of nickel cobalt managanese coated with zirconium. These materials are not four elements composite materials of nickel cobalt managanese zirconium.

TABLE 1
COMPARISON OF BATTERY PERFORMANCES THROUGH EXAMPLES

| | | discharge rate | low temperature | cycle |
|---|---|---|---|---|
| | | performance | power | performance |
| | | (10 C/1 C | performance | (1000 week |
| | | discharge | (10 C discharge | capacity |
| | | capacity ratio | resistance | retention |
| example | | %, 20 degrees | mΩ, −20 degrees | %, 20 degrees |
| number | sample | celsius) | celsius) | celsius) |
| target | / | >80 | <50 | >85 |
| vaulue | | | | |
| example1 | Li[Li_{0.042}Ni_{0.331}Co_{0.379}Mn_{0.237}Zr_{0.029}]O₂ | 86.3 | 39.7 | 90.8 |
| example2 | Li[Li_{0.088}Ni_{0.317}Co_{0.363}Mn_{0.227}Zr_{0.048}]O₂ | 91.0 | 31.9 | 92.3 |
| example3 | Li[Li_{0.142}Ni_{0.333}Co_{0.381}Mn_{0.238}Zr_{0.001}]O₂ | 92.2 | 30.3 | 92.1 |
| example4 | Li[Li_{0.142}Ni_{0.314}Co_{0.324}Mn_{0.314}Zr_{0.001}]O₂ | 91.3 | 35.2 | 90.4 |
| example5 | Li[Li_{0.036}Ni_{0.326}Co_{0.335}Mn_{0.326}Zr_{0.001}]O₂ | 89.4 | 41.2 | 90.4 |
| example6 | Li[Li_{0.088}Ni_{0.299}Co_{0.308}Mn_{0.299}Zr_{0.048}]O₂ | 91.3 | 36.1 | 91.7 |
| example7 | Li[Li_{0.036}Ni_{0.345}Co_{0.395}Mn_{0.247}Zr_{0.001}]O₂ | 85.2 | 39.7 | 90.8 |
| example8 | Li[Li_{0.075}Ni_{0.315}Co_{0.349}Mn_{0.305}Zr_{0.005}]O₂ | 88.7 | 38.5 | 92.5 |
| comparative | Li[Ni_{1/3}Co_{1/3}Mn_{1/3}]O₂ | 80.5 | 52.5 | 83.7 |
| example1 | | | | |
| comparative | Li[Li_{0.036}Ni_{0.405}Co_{0.335}Mn_{0.247}Zr_{0.001}]O₂ | 71.1 | 72.6 | 62.2 |
| example2 | | | | |
| comparative | Li[Li_{0.042}Ni_{0.331}Co_{0.379}Mn_{0.237}]O₂@[ZrO₂]_{0.029} | 78.0 | 64.3 | 85.3 |
| example3 | | | | |

Table 1 shows that the discharge rate performance, the low temperature power performance, and the cycle performance of the battery (using the positive electrode active material prepared by the method of the present disclosure) can achieve the desired objectives. The performances of the batteries formed in comparative example 1 and comparative example 2 do not achieve the desired objectives. The ratio of nickel, cobalt, manganese, and zirconium of the polynary composite oxide formed in comparative example 3 can be the same as that of the polynary composite oxide formed in example 1, the zirconium element being added only at the end. The material formed in comparative example 3 is not a single structure with an NaFeO₂ structure, and the battery formed in comparative example 3 does not achieve the desired objectives.

The embodiments shown and described above are only examples. Many details in this field are found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. Therefore, those of ordinary skill in the art can make various modifications to the embodiments without departing from the scope of the disclosure, as defined by the appended claims.

What is claimed is:

1. A polynary composite oxide of nickel cobalt managanese zirconium having a general formula Li[LiₖNi_{(a+b)}Co_{c}MnₐZr_{d}]O₂, wherein the element coefficients k, a, b, c and d meet the relation 0.03≦k≦0.15, 0.22≦a≦0.33, 0<b≦0.16, 0.30≦c≦0.40, 0.001≦d≦0.050.

2. The polynary composite oxide of claim 1, wherein k+6a+3b+3c+4d=3, and a+b≦c.

3. A method for manufacturing a polynary composite oxide comprising:
(1) preparing 0.1˜5.0 mol/L of solution A1 with soluble cobalt salt and soluble nickel salt, preparing 0.1˜5.0 mol/L of solution A2 with soluble manganese salt and soluble zirconium salt, mixing the solution A1 and the solution A2 by a certain stoichiometric ratio to obtain solution A, and strongly stirring the solution A, wherein the stirring rate is 100˜800 r/min;
(2) adding 0.2˜12.0 mol/L of precipitant and 0.5˜10.0 mol/L of accessory ingredient into the mixing solution A, and adjusting the mixing solution A to a pH value of 10.5˜12.0 to achieve gradual subsidence of intermediate B;
(3) washing the intermediate B to remove the remaining anions thereon;
(4) mixing the intermediate B and lithium salt to obtain an uniform precursor C of gray color, where the molar ratio of lithium element is less than 5˜20%;
(5) placing the precursor C power into a high temperature roller kiln to be decomposed and oxidated, so as to obtain primary powder D;
(6) placing the primary powder D and some organic phase into a preparation tank, stirring the primary powder and the organic phase at the rotating rate of 100˜500 r/min, pumping the slurry into the intermediate tank, and then heating and mixing the slurry to obtain rheological phase E, wherein the slurry is heated to 50˜90 degrees celsius and stirred for 0.5˜8 hours;
(7) heat treating the rheological phase E on the plate to obtain secondary powder F, wherein the heat treating temperature is 150˜450 degrees celsius, the heating treating time is 2˜6 hours;
(8) adding 0.03˜2.00 mass percent of surface additive into the secondary powder F, evenly mixing the surface additive and the second powder F, and sintering that with high temperature to obtain the polynary composite oxide having a general formula Li[LiₖNi_{(a+b)}Co_{c}MnₐZr_{d}]O₂, wherein the coefficients k, a, b, c and d meet the relation 0.03≦k≦0.15, 0.22≦a≦0.33, 0<b≦0.16, 0.30≦c≦0.40, 0.001≦d≦0.050, the sintering temperature is 750˜1000 degrees celsius, the sintering time is 4˜20 hours.

4. The method of claim 3, wherein k+6a+3b+3c+4d=3, and a+b≦c.

5. The method of claim 3, wherein the soluble cobalt salt is cobalt sulfate, cobalt chloride, cobalt acetate or cobalt nitrate, the soluble nickel salt is nickel sulfate, nickel chloride, nickel acetate or nickel nitrate, the soluble manganese salt is manganese sulfate, manganese chloride, manganese acetate or manganese nitrate, the soluble zirconium salt is zirconium sulfate, zirconium chloride, zirconium acetate, or zirconium nitrate.

6. The method of claim 3, wherein the precipitant is one or more selected from the group consisting of sodium hydroxide, potassium hydroxide, sodium carbonate, potassium carbonate, ammonium hydrogen carbonate, and lithium hydroxide; the accessory ingredient is ethylenediamine tetraacetic acid, ammonia, ammonium citrate, ethylenediamine, or ammonium acetate.

7. The method of claim 3, wherein the anions are is one or more selected from the group consisting of sulfate, chloride, acetate, nitrate, and or hydroxide.

8. The method of claim 3, wherein the lithium salt is one or more selected from the group consisting of lithium carbonate, lithium hydroxide, and lithium acetate.

9. The method of claim 3, wherein the organic phase is ethyl alcohol, propyl alcohol, ethylene glycol, or hexylene glycol.

10. The method of claim 3, wherein the surface additive is one or more selected from the group consisting of lanthanum oxide, lithium fluoride, lithium acetate, ammonium hydrogen fluoride, ammonium bicarbonate, aluminum fluoride, alumina, aluminum hydroxide, ammonium paratungstate, tungsten trioxide, ammonium molybdate, molybdenum oxide, zirconium oxide, zirconium hydroxide, manganese dioxide, cobaltosic oxide, cobalt hydroxide, citric acid, oxalic acid, basic magnesium carbonate, magnesium oxide, and calcium carbonate.

11. A positive electrode active material of a lithium battery comprising the polynary composite oxide having a general formula Li[LiₖNi_{(a+b)}Co_{c}MnₐZr_{d}]O₂, wherein the coefficients k, a, b, c and d meet the relation 0.03≦k≦0.15, 0.22≦a≦0.33, 0<b≦0.16, 0.30≦c≦0.40, 0.001≦d≦0.050.
